(19) United States
(12) Patent Application Publication
(10) Pub. No.: US 2002/0109329 A1
(43) Pub. Date: Aug. 15, 2002

(54) Auxiliary inertial drive device for a bicycle

(76) Inventor: Hsin-Hsiung Wang, Taichung (TW)

Correspondence Address: Renner, Otto, Boisselle & Sklar, Nineteenth Floor, 1621 Euclid Avenue, Cleveland, OH, 44115, US

(21) Appl. No.: 09/783,480

(22) Filed: Feb. 14, 2001

(51) Int. Cl. B62M 1/10; B62K 3/00

(52) U.S. Cl. 280/212; 280/281.1

(57) ABSTRACT

An auxiliary inertial drive device for a bicycle includes a casing mounted on a crossbar of a bicycle. A shaft is rotatably mounted in the casing parallel to a main shaft of the bicycle. The shaft includes a first end extending through the casing and a second in the casing. A driven wheel is centrally secured on the drive sprocket wheel and a drive wheel is secured on the first end of the shaft. The drive wheel is driven by the driven wheel via a driving strip. A gear is secured on the second end of the shaft for driving a gear set that is mounted in the casing and has at least one flywheel rotated to provide inertia to the bicycle for lengthening coasting distance.

### BACKGROUND OF THE INVENTION

1. Field of the Invention

The present invention relates to an auxiliary drive device, and more particularly to an auxiliary inertial drive device for a bicycle.

2. Description of Related Art

A conventional drive device for a bicycle in accordance with the prior comprises a main shaft rotatably extending through the main frame of the bicycle and securely connected to a sprocket wheel. A crank is securely attached to each end of the main shaft, and a pedal is rotatably attached to the free end of each crank. A chain is mounted around the sprocket wheel connected to the main shaft and around another sprocket wheel connected to the rear wheel. The sprocket wheel connected to the rear wheel will only drive the rear wheel in one direction and will “free wheel” or “coast” in the other direction. The rider alternately presses the pedals to rotate the sprocket wheel connected to the main shaft so the chain will drive the sprocket wheel mounted on the rear wheel of the bicycle so that the bicycle is driven ahead. There is no auxiliary power supplied to the drive device of the bicycle so that the coasting distance of the bicycle on a level surface depends only on the momentum of the bicycle and rider when the rider stops pressing the pedals.

The present invention has arisen to mitigate and/or obviate the disadvantages of the conventional drive device of the bicycle.

### SUMMARY OF THE INVENTION

The main objective of the present invention is to provide an auxiliary drive device for a bicycle. The auxiliary inertial drive device in accordance with the present invention can significantly lengthen the coasting distance of a bicycle when rider stops pressing the pedals. The auxiliary inertial drive device comprises a clutch bearing mounted around the main shaft, and a drive sprocket wheel and a driven wheel respectively secured around the clutch bearing so that the drive sprocket wheel and the driven wheel are rotated simultaneously. A casing has a division wall longitudinally formed to divide the internal space of the casing into two compartments. A change speed gear set with at least one flywheel mounted in one of the two compartments. A drive wheel is pivotally mounted on the external periphery of the casing. A shaft is centrally secured in the drive wheel and rotatably laterally extends into the casing to drive the change speed gear set and the flywheel. The drive wheel and the driven wheel are connected a driving strip. Consequently, the inertia of the rotating flywheel will provide an auxiliary inertial drive force to the bicycle via the driving strip to lengthen the coasting distance of the bicycle when the rider stops pressing the pedals.

Further benefits and advantages of the present invention will become apparent after a careful reading of the detailed description with appropriate reference to the accompanying drawings.

### BRIEF DESCRIPTION OF THE DRAWINGS

FIG. 1 is a side plan view of an auxiliary inertial drive device for a bicycle in accordance with the present invention showing how the auxiliary inertial drive device mounted on a bicycle;

FIG. 2 is a perspective view of the auxiliary inertial drive device for a bicycle in FIG. 1;

FIG. 3 is a cross sectional side plan view of the auxiliary inertial drive device for a bicycle in FIG. 1; and

FIG. 4 is a top plan view of the auxiliary inertial drive device for a bicycle in FIG. 3.

### DETAILED DESCRIPTION OF THE INVENTION

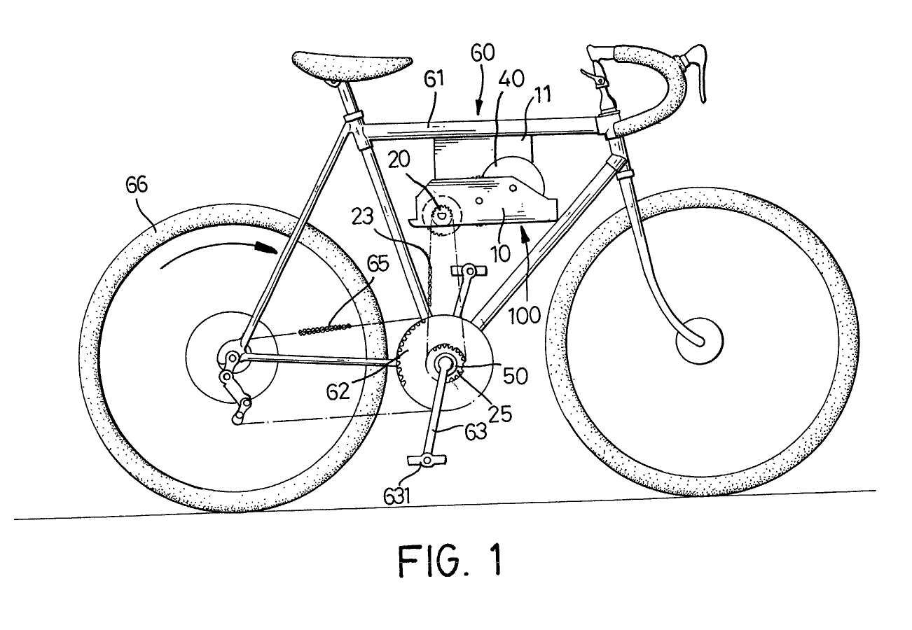

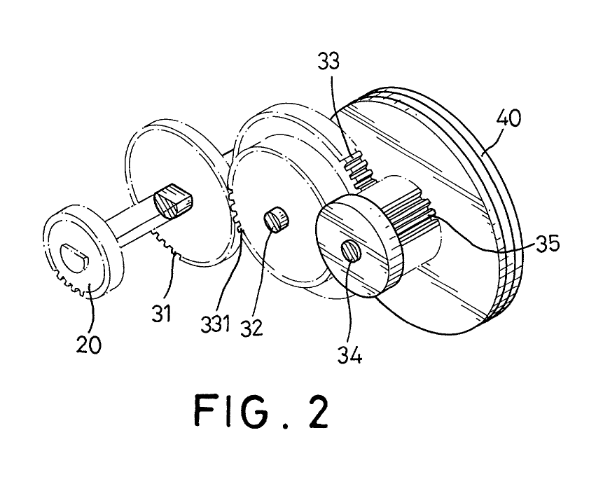

With reference to the drawings and initially to FIGS. 1 and 2, an auxiliary inertial drive device in accordance with the present invention is mounted on a crossbar (61) of a bicycle (60) and comprises a casing (10) with a division wall (11) formed to divide the internal space of the casing (10) into a first compartment (110) and a second compartment (120). The division wall (11) is parallel and attached to the crossbar (61) of the bicycle (60). The first compartment (110) is larger than the second compartment (120).

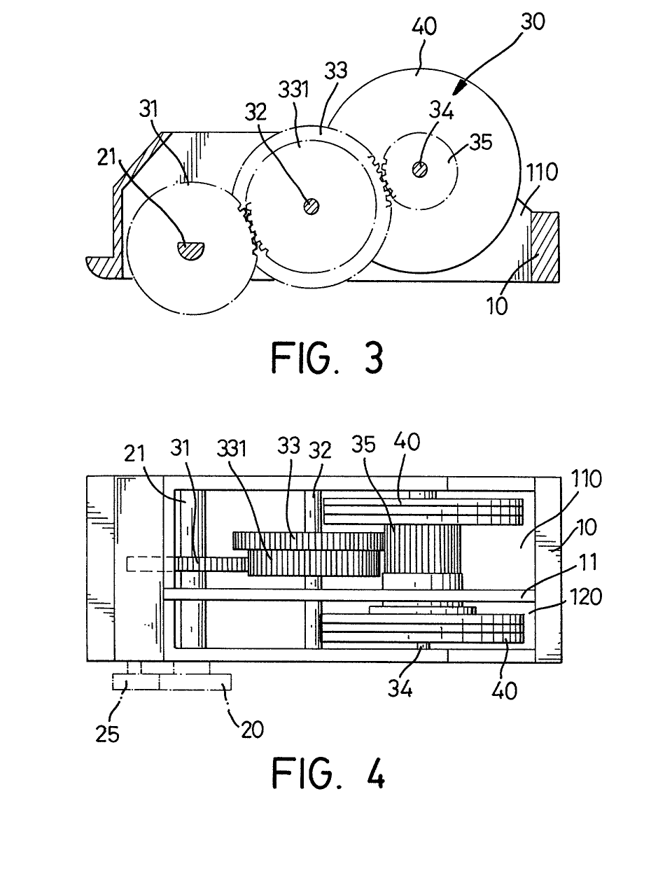

With reference to FIGS. 1, 2, 3 and 4, a drive wheel (20) is mounted outside the casing (10) on a shaft (241) that rotatably extends laterally into the first compartment (110) of the casing (10) to drive a gear set (30). A driven wheel (25) is centrally and axially mounted on a drive sprocket wheel (62) of the bicycle (60) so that the driven wheel (25) and the drive sprocket wheel (62) of the bicycle (60) are rotated at the same time. A clutch bearing (50) is centrally mounted in the driven wheel (25) and the drive sprocket wheel (62) of the bicycle (60). The bicycle (60) includes a main shaft (not shown) extending through and secured in the clutch bearing (50) and two cranks (63) each having one end mounted on opposite ends of the main shaft and the other end having a pedal (631) attached to the crank (63). A driving strip (23) is mounted around and connects the drive wheel (20) and the driven wheel (25). The driving strip (23) may be a belt or a chain.

With reference to FIGS. 2, 3 and 4, the gear set (30) is mounted in the first compartment (110) of the casing (10) and includes a bull gear (31) secured on the internal end of the shaft (21). A counter shaft (32) is rotatably mounted in the first compartment (110) parallel to the shaft (21). A counter shaft bull gear (33) and a counter shaft pinion (331) are securely mounted around the counter shaft (32) so that the counter shaft bull gear (33) and the counter shaft pinion (331) are rotated simultaneously. The counter shaft bull gear (33) and the counter shaft pinion (331) may be integrated. The counter shaft pinion (331) engages with the bull gear (31) mounted on the shaft (21). A flywheel axle (34) is rotatably mounted in the first compartment (110) of the casing (10) and extends into the second compartment (120) through the division wall (11). A flywheel pinion (35) is securely mounted around the flywheel axle (34) and engage with the counter shaft bull gear (33). At least one flywheel (40) is securely attached on one end of the flywheel axle (34) and is partially received in a corresponding one of the two compartments (110, 120) of the casing (10). In the preferred embodiment of the present invention, there are two flywheels (40) mounted on two opposite ends of the flywheel axle (34), and each is partially received in a corresponding one of the two compartments (110, 120) of the casing (10).

With reference to FIGS. 1, 2, 3 and 4, in operation when a force is applied to the pedal (631) by rider, the drive sprocket wheel (62) drives a rear wheel (66) of the bicycle (60) via a chain (65), and the driven wheel (25) drives the drive wheel (20) via the driving strip (23) so that the gear set (30) is rotates the flywheel (40) builds inertia in the flywheel (40). When the force applied by the rider is reduced or stopped, the flywheel (40) continues to drive the drive wheel (20) to drive the driven wheel (25) so that the drive sprocket wheel (62) will continue to drive the rear wheel (66) to keep moving the bicycle (60) ahead. The cranks (63) and the pedals (631) are not moved with the driven wheel (25) and the drive sprocket wheel (62) because the clutch bearing (50) is mounted between the main shaft of the bicycle (60) and the driven wheel (25) and the drive sprocket wheel (62). Consequently, the auxiliary inertial drive device (100) in accordance with the present invention can lengthen the coasting distance due to the inertia of the rotating flywheel (40).

Although the invention has been explained in relation to its preferred embodiment, it is to be understood that many other possible modifications and variations can be made without departing from the spirit and scope of the invention as hereinafter claimed.

What is claimed is:

1. An auxiliary inertial drive device for a bicycle including a main shaft rotatably mounted in the bicycle and a drive sprocket wheel rotatably mounted around the main shaft, the auxiliary inertial drive device comprising:
a casing adapted to be mounted on a crossbar of a bicycle;
a shaft rotatably mounted in the casing and adapted to be in parallel to the main shaft of the bicycle, the shaft including a first end extending through the casing and a second end in the casing;
a driven wheel centrally secured on the drive sprocket wheel and a drive wheel secured on the first end of the shaft, the drive wheel driven by the driven wheel via a driving strip; and
a gear secured on the second end of the shaft for driving a gear set that is mounted in the casing and has at least one flywheel rotated to provide inertia to the bicycle for lengthening coasting distance.

2. The auxiliary inertial drive device for a bicycle as claimed in claim 1, wherein the casing comprises division wall longitudinally formed to divide the internal space into a first compartment to receive the gear set and a second compartment to receive another flywheel, the two flywheels rotate simultaneously, and the division wall extending to the crossbar of the bicycle and attached to the crossbar to hold the casing in place.

3. The auxiliary inertial drive device for a bicycle as claimed in claim 1, wherein the driving strip is a chain.

4. The auxiliary inertial drive device for a bicycle as claimed in claim 1, wherein the driving strip is a belt.

5. The auxiliary inertial drive device for a bicycle as claimed in claim 1 further comprising a clutch bearing adapted to be mounted around the main shaft of the bicycle, the driven wheel of the auxiliary inertial drive device secured on the clutch bearing.

6. The auxiliary inertial drive device for a bicycle as claimed in claim 1, wherein the gear set comprises:
a counter shaft rotatably mounted in the first compartment of the casing and parallel to the shaft;
a counter shaft bull gear securely mounted around the counter shaft;
a counter shaft pinion securely mounted around the counter shaft on one side of the counter shaft gear and engaging with the bull gear mounted on the shaft;
a flywheel axle rotatably mounted in the casing parallel to the counter shaft, a flywheel mounted on a corresponding one of two opposite ends of the axle; and
a flywheel pinion securely mounted around the axle and engaged to the counter shaft bull gear to drive the flywheel.

7. The auxiliary inertial drive device for a bicycle as claimed in claim 6, wherein the counter shaft bull gear and the counter shaft pinion are formed integrally.
